(19) United States
(12) Patent Application Publication
(10) Pub. No.: US 2006/0101645 A1
(43) Pub. Date: May 18, 2006

(54) Integrated cradle mounting system for a hybrid-electric drive

(76) Inventor: Kevin T. Stone, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/069,019

(22) Filed: Feb. 28, 2005

Related U.S. Application Data
(60) Provisional application No. 60/628,027, filed on Nov. 15, 2004.

(51) Int. Cl. B21D 53/88; B62D 21/00

(52) U.S. Cl. 29/897.2; 180/312; 180/292; 180/65.2

(57) ABSTRACT

This invention is a system that provides the structural and positioning framework to mount the components of a hybrid-electric drive together as a single assembly for ease of installation in and removal from a vehicle during assembly and maintenance. This cradle assembly may also have panels for heat shielding and directing air flow, and various hardware supports for routing plumbing components and electrical wiring. The cradle assembly includes an optional matching dolly accessory for ease of moving the cradle assembly around without the aid of a lifting tool such as a fork lift.

### CROSS-REFERENCE TO RELATED APPLICATIONS

This application claims the benefit of U.S. Provisional Application 60/628,027 filed Nov. 15, 2004 under 35 U.S.C. 119(e).

### FIELD OF THE INVENTION

The field of the invention relates, in general, to integrated cradle mounting systems for vehicle drives, and, in particular, to integrated cradle mounting systems for hybrid-electric drive systems.

### BACKGROUND OF THE INVENTION

During manufacture/assembly of heavy-duty vehicles (e.g., buses, heavy-duty trucks), drive components of a drive system are typically installed separately, creating extra assembly processes, inventory, and time for the OEM vehicle manufacturer to install the drive system. Typical installation and removal procedures are limited to one component at a time, removing all the interfering components, e.g., an engine, a transmission, a compressor, a hydraulic pump. These problems and others are addressed by the present invention.

### SUMMARY OF THE INVENTION

The present invention includes an integrated cradle mounting assembly for a hybrid-electric drive, where a cradle assembly with all the drive components (e.g., engine, generator, motors, combiner gearbox, inverters, radiator and fans, electrically driven hydraulic pump and air compressor accessories, electronics boxes, alternator, braking resistors, and all the interconnecting wiring, cable, plumbing, and hoses required for electrical power, digital data, air intake and cooling liquids) slides in and out on, rests on, and is fastened to the frame rails of a heavy duty vehicle (e.g., bus, truck) for ease of assembly and service, saving a significant amount of time. When the cradle assembly is installed it is hard mounted to the vehicle frame rail structure. The cradle provides vibration isolation mounting wherever necessary for all the drive components including the engine and electric drive motors.

The integrated cradle mounting assembly for a hybrid-electric drive is advantageous in that it saves the manufacturer a lot of design (and design time) to design the structural mounting and connections of the various components on or within the cradle mounting assembly. Similarly, the integrated cradle mounting assembly for a hybrid-electric drive is also advantageous in that it saves the manufacturer a lot of assembly processes and labor during the drive system installation.

During assembly of the integrated cradle mounting assembly the cradle framework rests on a heavy-duty dolly with castor wheels for ease of movement.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a front perspective view photograph of an embodiment of the integrated cradle mounting assembly for a hybrid-electric drive with various components of the integrated cradle mounting assembly labeled.

FIG. 2 is a rear perspective view photograph of the integrated cradle mounting assembly of FIG. 1, from a direction opposite that in FIG. 1, with various components of the integrated cradle mounting assembly labeled.

FIG. 3 is a top perspective view photograph of an embodiment of a cradle frame of the integrated cradle mounting assembly illustrated in FIG. 1.

FIG. 4 is a top perspective view of the integrated cradle mounting assembly.

FIG. 5 is a perspective view of an embodiment of chassis frame rails 112 of a heavy duty bus.

FIG. 6 is a perspective view of an embodiment of a dolly and an embodiment of a cradle adapter for the integrated cradle mounting assembly.

### DETAILED DESCRIPTION OF A PREFERRED EMBODIMENT

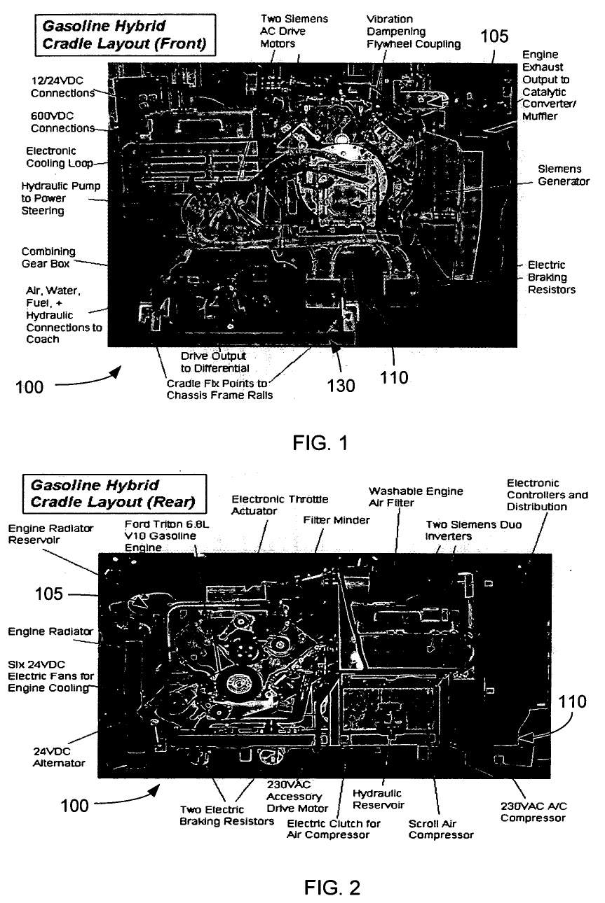

With reference to FIGS. 1-4, an embodiment of an integrated cradle mounting assembly 100 for a hybrid-electric drive 105 of a heavy-duty vehicle (e.g., bus, heavy-duty truck) will now be described. Although the integrated cradle mounting assembly 100 will be described in conjunction with a hybrid-electric drive 105, the cradle mounting assembly 100 may be used with other types of drives. Further, although the integrated cradle mounting assembly 100 will be described in conjunction with a heavy-duty vehicle, and, in particular, a bus, the cradle mounting assembly 100 may be used with other types of vehicles.

In the embodiment shown, the cradle assembly 100 provides one assembly for substantially all the drive components, except for the energy storage system and a rooftop radiator, of the hybrid-electric drive 105 of a heavy duty vehicle (e.g., bus, truck). These components include, but not by way of limitation, a Ford Triton 6.8 L V-10 gasoline internal combustion automotive engine, two Siemens AC drive motors, combining gear box, a vibration dampening flywheel coupling, an engine exhaust output to catalytic converter/muffler, a Siemens generator, electric braking resistors, a drive output (to differential), air, water, fuel and hydraulic connections (to coach), hydraulic pump to power steering, electronic cooling loop, 600 VDC connections, 12/24 VDC connections, an electronic throttle actuator, a filter minder, a washable engine air filter, two Siemens DUO-Inverters, electronic controllers and electrical distribution, a 230 VAC A/C compressor, a scroll air compressor, a hydraulic reservoir, an electric clutch for air compressor, a 230 VAC accessory drive motor, a 24 VDC alternator, six 24 VDC electric fans for engine cooling, an engine radiator, and an engine radiator reservoir. The electrical generator and/or alternator is attached to the internal combustion engine. In alternative embodiments of the cradle assembly 100, the cradle assembly 100 may include one or more of these components, in particular, the 230 VAC A/C compressor may be part of the vehicle HVAC system or mounted elsewhere on the vehicle to facilitate connections for the heat transfer medium.

The cradle assembly 100 includes compartment dividers and/or cowlings for heat shielding and/or to direct cooling air flow. The cradle assembly 100 includes shock and vibration isolation mounts for the engine, and one or more drive motors. The cradle assembly 100 includes mounts for a gear reduction box. The cradle assembly 100 may include one or more fuel cells. The cradle assembly 100 includes a cooling system with radiator and fans for one or more of engine cooling, fuel cell cooling, braking resistor cooling, inter-cooling for turbo charger engine intake air, cooling for electrical components including but not limited to propulsion driver motors and inverters, and cooling for an energy storage system. The cooling system includes a liquid reservoir and a fluid pump. The cradle assembly 100 includes various attached supporting hardware to mount and guide one or more of various liquid and air plumbing components, and electrical cables, harnesses, and connectors.

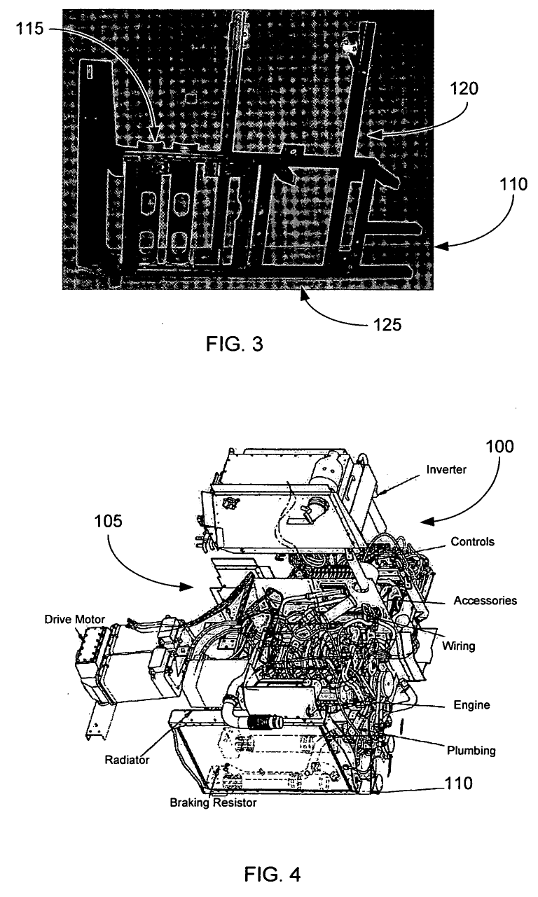

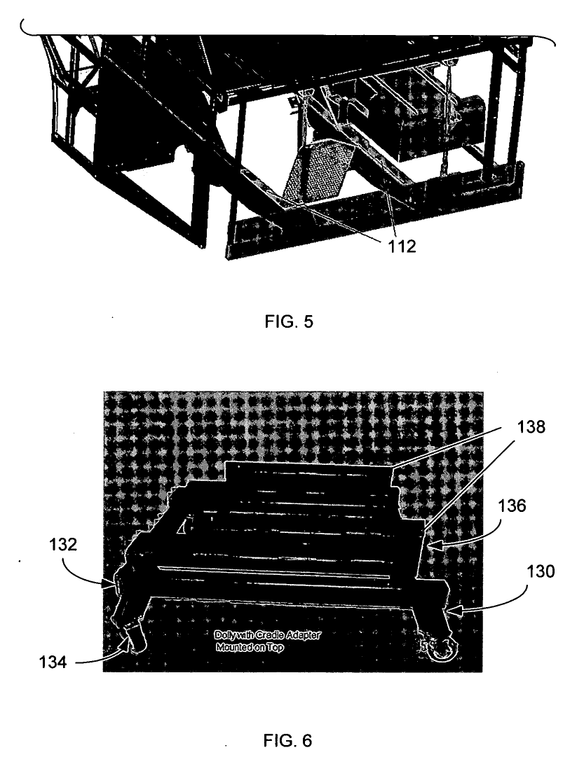

The components are carried by a cradle frame 110 (FIG. 3), which slides in and out of chassis frame rails 112 (FIG. 5) of a heavy duty vehicle (e.g., bus, truck). The cradle frame 110 includes curved mounting frames 115 for positioning and securing the round body of the braking resistor. A sheet of rubber or similar material is bonded to the inside of the curved mounting frames and provides impact shock and vibration protection and isolation for the braking resistor body. The cradle frame 110 is made from stainless steel to resist the corrosive environment of an engine compartment that is somewhat open to ambient air, moisture, and road chemicals. For ordinary steel the framework would have to be coated to resist any weakening of the structure due to rust. The cradle frame 110 includes a cradle lengthwise support framework 120 that aligns inside or outside the vehicle support frame rails, and a cradle cross member support framework 125 that rests on the vehicle support frame rails.

During assembly of the heavy-duty vehicle, the hybrid-electric drive 105 is easily installed into the vehicle by lifting and sliding the cradle assembly 100 with the drive components along the chassis frame rails of the heavy duty vehicle. A friction reducing strip such as Teflon is added to the top of the vehicle frame rails to facilitate this sliding installation and removal of the cradle frame 110 thereon. A fork lift tool mates to the cradle frame 110 for facilitating the lifting of the cradle assembly 100. After the cradle is slid into position it is fixed to the vehicle frame rails and the drive motors' combining gearbox is mechanically connected to the differential. Connecting the other interfaces; fuel, exhaust, air intake, compressed air, hydraulic fluid, coolant, 600 VDC high voltage electric, 12/24 VDC low voltage electric, and control and data signals; completes the vehicle installation.

During the assembly of the components onto the cradle itself the cradle frame 110 rests on a heavy-duty dolly 130 (see FIGS. 1, 6) to facilitate movement along the production line. The dolly 130 includes a rectangular frame 132 supported for rolling movement on castor wheels 134. The frame 132 includes a rectangular understructure of steel channels and tubes. A cradle adapter 136 includes a bolt-on interface frame that can be changed to emulate the frame rails 112 (FIG. 5) of different vehicles and different cradle designs. The cradle adapter 136 includes rails 138 that emulate the length and configuration of the matching vehicle frame rail structure 112. The cradle adapter 136 is mounted on the dolly 130. As part of providing mobility for the cradle assembly 100 the dolly 130 may have extended or extendable support arms with or without a castor wheel to provide anti-tipping support during any stages of assembly where the partially installed components unbalance the cradle assembly 100. The dolly 130 provides mobility for ease of moving the cradle assembly 100 during assembly and maintenance.

During maintenance of one or more components of the hybrid-electric drive 105, the drive 105 may be removed from the vehicle (or partially moved with respect to the vehicle) by sliding the cradle assembly 100 off (or partially off) of the chassis frame rails of the heavy duty vehicle and onto the dolly 130. The components of the hybrid-electric drive 105 are much easier to access with the components of the hybrid-electric drive 105 out of the vehicle and on the movable dolly 130.

Thus, the cradle assembly 100 facilitates assembly and service of the vehicle because it easily slides in and out of the vehicle along the frame rails as a complete assembly, thus, saving a significant amount of time. The integrated cradle mounting assembly 100 also is advantageous in that it saves the manufacturer a lot of design (and design time) to design the structural mounting, connections, and assembly processes of the various components on or within the cradle mounting assembly 100.

It will be readily apparent to those skilled in the art that still further changes and modifications in the actual concepts described herein can readily be made without departing from the spirit and scope of the invention as defined by the following claims.

What is claimed is:

1. A method of using an integrated hybrid-electric drive cradle mounting assembly with a heavy-duty vehicle including structural frame rails therein, comprising:
providing an integrated pre-assembled hybrid-electric drive cradle mounting assembly including a plurality of hybrid-electric drive components and a structural framework that carries and positions the components for support and ease of connecting to other components, and secures the integrated hybrid-electric drive cradle mounting assembly to the structural frame rails of the heavy-duty vehicle;
adding the integrated hybrid-electric drive cradle mounting assembly to the heavy-duty vehicle by at least one of sliding and lifting the integrated pre-assembled hybrid-electric drive cradle mounting assembly into the heavy-duty vehicle on the structural frame rails of the heavy-duty vehicle.

2. The method of claim 1, wherein adding includes adding the integrated hybrid-electric drive cradle mounting assembly to the heavy-duty vehicle during manufacture of the heavy-duty vehicle.

3. The method of claim 1, wherein adding includes moving the integrated hybrid-electric drive cradle mounting assembly from a cradle mounting assembly dolly to the structural frame rails of the heavy-duty vehicle after working on one or more of the hybrid-electric drive components while the integrated hybrid-electric drive cradle mounting assembly was on the cradle mounting assembly dolly.

4. The method of claim 1, further including removing the integrated hybrid-electric drive cradle mounting assembly from the heavy-duty vehicle by at least one of sliding and lifting the integrated pre-assembled hybrid-electric drive cradle mounting assembly out of the heavy-duty vehicle on the structural frame rails of the heavy-duty vehicle.

5. The method of claim 4, wherein removing includes moving the integrated hybrid-electric drive cradle mounting assembly from the structural frame rails of the heavy-duty vehicle to a cradle mounting assembly for working on one or more of the hybrid-electric drive components while the integrated hybrid-electric drive cradle mounting assembly is on the cradle mounting assembly dolly.

6. The method of claim 4, wherein removing includes removing the integrated hybrid-electric drive cradle mounting assembly from the heavy-duty vehicle to replace the integrated hybrid-electric drive cradle mounting assembly with another integrated hybrid-electric drive cradle mounting assembly.
